(19) United States
(12) Patent Application Publication
(10) Pub. No.: US 2003/0194928 A1
(43) Pub. Date: Oct. 16, 2003

(54) Conveyor belting for handling bakery goods

(76) Inventors: Florian S. Zabron, Orchard Park, NY (US); Paul R. Powers, Lawrenceville, GA (US); Ernest E. Atkins, Phoenix, AZ (US)

Correspondence Address: David L. Principe, Hodgson Russ LLP, Suite 2000, One M&T Plaza, Buffalo, NY, 14203-2391, US

(21) Appl. No.: 10/121,380

(22) Filed: Apr. 12, 2002

(51) Int. Cl. B32B 5/26; D03D 15/00; B32B 27/02; B32B 27/12; D03D 19/00; D04G 1/00; D04B 1/00; D04C 1/00; D03D 9/00; D04B 21/00; B32B 27/04; B32B 5/02

(52) U.S. Cl. 442/35; 442/49; 442/43; 442/46; 442/123

(57) ABSTRACT

The disclosure is of a conveyor belting particularly useful in conveying edible dough and bakery articles made therefrom during bakery operations. The belting includes a woven scrim or strength member, a batt of non-woven cotton fibers that is needled to the scrim, and an elastomer that is impregnated into the combined scrim and batt. The belting is provided with an embossed impression surface that simulates the texture of a traditional woven cotton belt.

### FIELD OF INVENTION

The present invention relates to conveyor belting and more particularly relates to conveyor belting useful in conveying bakery goods.

### BACKGROUND OF THE INVENTION

Automated bakeries utilize textile belting materials, principally woven cotton belting, for conveying dough pieces through a variety of process operations. For example, raw dough is supported on and carried through processing operations such as thickness rolling, scoring, transfer (to and from ovens, etc.), cutting, shaping, and the like on woven cotton belting. The baked article is also transferred through various operations such as counting, packaging, etc. on such belting.

Traditional woven cotton belts are woven to width and are not suitable to be slit from a master roll for subsequent use in bakeries because the edges would unravel. Also, there is a need for a lighter, stronger belting that will resist edge fraying.

### SUMMARY OF THE INVENTION

The present invention meets the above-described need by providing a non-woven cotton belting that is suitable for conveying edible dough and baked articles. The non-woven cotton belting includes a woven scrim or strength member, a batt of non-woven cotton fibers that is needled to the scrim, and an elastomer that is impregnated into the combined scrim and batt. Finally, the belting is embossed with a plurality of protuberances forming a surface pattern having a similar texture as traditional woven cotton belting.

### BRIEF DESCRIPTION OF THE DRAWINGS

The invention is illustrated in the drawings in which like reference characters designate the same or similar parts throughout the figures of which:

FIG. 1 is a perspective view of an endless belt of the present invention;

FIG. 2 is an enlarged cross-sectional, side elevation view of a portion of the belting of the invention after the batt has been needled to the scrim;

FIG. 3 is an enlarged cross-sectional, side elevation view of a portion of the belting after the belting has been impregnated with an elastomer; and,

FIG. 4 is an enlarged cross-sectional, side elevation view of a portion of the belting after the belting has been embossed with a surface pattern.

### DETAILED DESCRIPTION

FIG. 1 is a view in perspective of an endless belt 10 of the invention, useful for conveying dough through bakery process operations such as thickness rolling, scoring for dimensions, dough transfer, cutting of shapes and like operations. The belt 10 may also be used to convey baked articles received from bakery ovens, in baking and packaging procedures. The belt 10 is a flat web or sheet made endless by the joinder of ends at seam 12. The belt 10 may be employed with conventional conveyor apparatus for support and endless running.

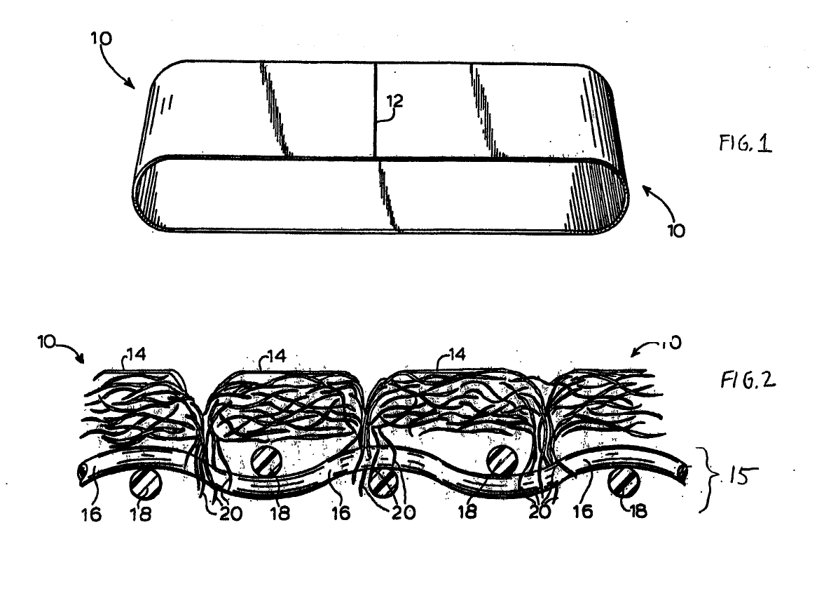

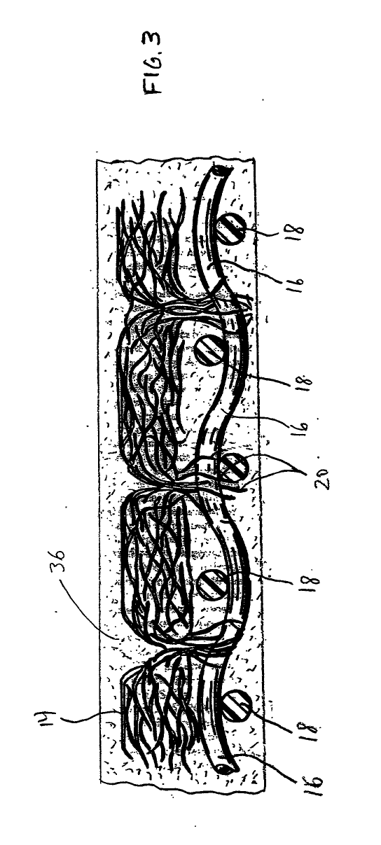

Turning to FIG. 2, the belt 10 comprises a surface 14 provided by a batt of carded cotton fibers. The surface 14 together with the body of the batt of cotton fibers is secured to a scrim 15 or strength member of interwoven machine direction yarns 16 and cross-machine direction yarns 18. The scrim 15 may be formed out of textile yarns in the machine direction and formed out of spun polyester yarns in the cross-machine direction. The scrim 15 may be woven or knitted. As shown, the machine direction yarns 16 and the cross-machine direction yarns 18 are provided in an open weave cloth as the scrim 15. Any weave may be used, a plain weave being stable and therefore advantageous.

The machine direction textile yarns 16 should have a relatively high tensile breaking strength, for example on the order of at least about 20 lbs. per inch and preferably greater than 50 lbs. per inch. The machine direction textile yarns 16 will have low stretch properties, for example on the order of at least about 4 percent to 5 percent (½ normal breaking load) to about 15 percent to 20 percent. Further, it is important that the machine direction yarns 16 exhibit uniformity in their shrink characteristics, i.e., machine direction yarns of a high degree of shrinkability should not be mixed with machine direction yarns of a low degree of shrinkability to minimize buckling or cockling of the finished belting 10. In that respect, the machine direction yarns 16, may be selected from a wide variety of synthetic yarns, such as polyester, polyamide, and like yarns. The machine direction yarns 16 will be spun yarns or the like having a tendency to absorb and hold the polymeric elastomeric material 36.

The nature of the cross-machine direction yarns 18 is not critical and the yarns 18 may comprise any conventional synthetic or natural fiber yarns. Advantageously, the denier of the machine direction and cross-machine direction yarns and the density of the weave is selected to provide a scrim weight of from between about 4 ounces/square yard to about 40 ounces/square yard for optimum strength.

The batt may be of randomly oriented natural carded cotton fibers. As an alternative, the fibers may be directionally oriented within the batt by methods known to those of ordinary skill in the art.

The batts of staple cotton fibers selected for needling to the textile yarns advantageously have a weight of from between about 2 oz./square yard to 100 oz./square yard. The staple fibers may have different weights and a wider denier range than that which is preferred for yarns 16, 18. The batts may be preneedled using conventional techniques to obtain some integrity of the staple fibers prior to needling the batt to the scrim.

Securement of the cotton fibers 20 to the woven yarns 16, 18 is effected by needling of the batt of cotton fibers to the underlying woven yarns 16, 18 so that the cotton fibers 20 from the surface 14 layer are interengaged with the yarns 16, 18. A second batt may be needled to the other side of the scrim 15. The technique of needling is well-known and the details need not be recited here; see for example U.S. Pat. No. 2,059,132 describing conventional needling operations and which is incorporated herein by reference. The coarseness of the belting needles used, the barb configurations, number, size and other variables are dependent somewhat on the degree of openness between the textile yarns, so as to avoid rupture of the textile yarns. In general a No. 28 gauge needle is preferred, with the barbs oriented so as not to tear the machine direction yarns 16. Needling is carried out to produce a needled fabric scrim having a weight within the range of from between 6 oz./square yard to about 90 oz./square yard.

Following needling, it may be advantageous to calendar those needled beltings where further consolidation is desired, particularly in those beltings where a web of staple fibers is needled only to one side of the scrim. Calendaring is accomplished by passing the fabric of the belting 10 through the gap of opposed, heated platen rollers wherein the gap is adjusted to provide a belting 10 of any desired thickness. The calendaring step serves to further compact and consolidate the staple fibers to reduce fluid permeability of the needled belting. This calendaring enhances retention of the liquid elastomeric material 36 received by the needled belting in the saturation step. Generally it is desirable to have a belting ready for saturation, characterized by its ability to accept and retain the elastomeric liquid precursor until solidification occurs. If the needled belting lacks this characteristic, calendaring may be advantageous. Calendaring is not generally necessary if webs of staple fibers have been needled to both outer surfaces of the scrim 15.

If desired, the needled and possibly calendared belting 10 is heat set in an oven (not shown) to selectively shrink the fabric comprising the scrim 15 before the belting 10 is subjected to the saturation step. During heat setting, the fabric may be tensioned in the machine direction under from between about 0.5 lbs. per inch to about 20 lbs. per inch. This tensioning eliminates a large degree of stretching in the final product, and obviates wrinkles across the width and along the length of the belting 10 of the present invention. Heat setting is carried out under hot air temperatures dependent on the nature of the fibers and yarns employed in the needled fabric scrims. Those skilled in the art will know which temperatures to select.

A wide range of liquid polymeric saturants may be employed for saturation of the belting 10. Because the belting 10 comes into contact with edible foodstuffs the belting 10 has to be impregnated with an FDA approved elastomer. Representative are the liquid precursors of polyurethane, polyvinyl chloride, neoprene, styrene-butadiene and like non-cellular polymeric resins. Particularly preferred polymeric saturants are the liquid carboxylated acrylonitrile-butadiene copolymer -7latex resins. The acrylonitrile-butadiene copolymer elastomers formed from them are highly flexible, crack-resistant even at low temperatures and form strong bonds with the textile components of the fabric scrim of the invention. Liquid polymeric saturants without carriers or solvents can also be used as those skilled in the art will appreciate.

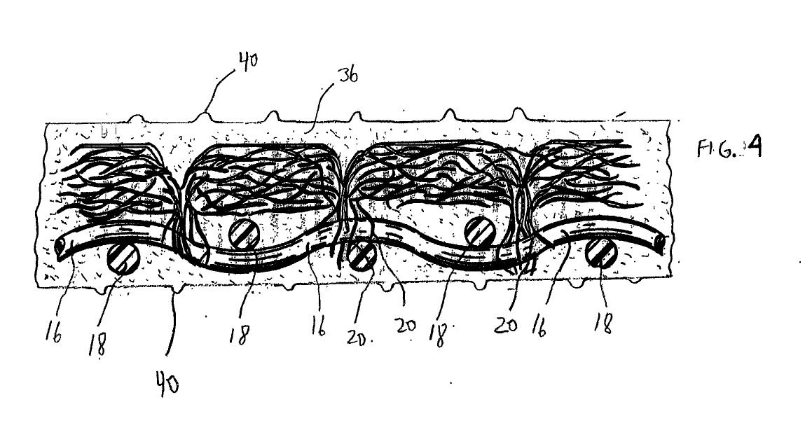

Turning to FIG. 3, the saturation of the heat set and needled belting 10 will provide high loading of elastomer, substantially penetrating the textile fabric scrim 15 so as to encapsulate the fibrous layer. The majority of voids in the textile fabric scrim and in the fibrous layer are filled with the elastomeric material 36 so that elastomer is distributed throughout the body of the final product. Curing may be affected by any means appropriate for the elastomeric saturant. For example, the belting 10 may be cured by heat for heat curable elastomers. The saturated belting 10 is passed through a heated platen press at a temperature sufficient to cure the elastomer material 36, and if desired, the saturated belting 10 is simultaneously pressed. Pressures of from between about 50 lbs. per square inch to about 200 lbs. per square inch are practical and illustrative of pressures that may be employed. The saturated belting 10 may be pressed and cured under pressures of from between about 90 lbs. per square inch to 130 lbs. per square inch. The addition of the elastomers will further consolidate the non-woven fibers, add abrasion resistance, and impart slittability of the non-woven fabric. The elastomers will be a cross-linking thermoset system similar to acrylics and urethanes.

By using a patterned surface platen, the belting 10 is molded during curing to mold the impregnated material so as to form at least one planar surface with discontinuities 40 or raised portions, i.e., an impression surface. The impression surface is molded to provide a similar appearance and function as the surface of a traditional woven cotton belt. The raised discontinuities 40 may be of any geometric configuration such as semi-hemispheres, bars, etc. raised off the lower portion 14 of the belting 10. The embossed or smoothed surfaces can be varied to address overall surface needs necessary in the kneading of dough and production of bakery goods.

The saturation of the belting 10 of the present invention will be such that the cured elastomeric material 36 constitutes from between about 50 percent to about 500 percent, preferably 100 percent to 350 percent of the belting weight.

An effective amount of an antimicrobial biocidal or biostatic substance may be incorporated into the polymeric elastomeric material 36 to resist growth of mold, mildew, fungus, yeast, viruses, and Gram-positive and Gram-negative bacteria including Staph, E. coli, Klebsiella and Salmonella on the belting 10. The antimicrobial compounds include the following: Ca(OH)₂, MgO, ZnO, Al₂O₃, CuO, Silver, Zinc Pyrithione, Methyl-N(2-benzimidazoloyl)-carbamat, N-buthylbenso-thiazolinone, 10¹10-oxybisphenoxyarsin, Tebuconazole, Imidazole, Silver-Sodium Hydrogen Zirconium Phosphate, and mixtures thereof. Other chemical compounds having known anti-microbial biocidal or biostatic tendencies may also be used. The antimicrobial agent could also be introduced into the yarns before they are woven or knitted into the scrim 15. Also, the batt could be supplied with an antimicrobial agent prior to being needled to the scrim 15. An alternative approach is to spray or otherwise apply a surface coating of the antimicrobial agent onto the belting 10. For a more detailed discussion of the use of the antimicrobial agent in a coating process, reference is made to U.S. Pat. No. 5,238,749 to Cueman et al., and to use of the antimicrobial agent in a surgical drape, reference is made to U.S. Pat. No. 5,069,907 to Mixon et al., the disclosures of which are incorporated herein by reference.

The non-woven cotton design of the present invention will have many of the properties associated with woven cotton plied belting such as edge integrity, oil absorption, thickness, etc. The present invention enables the non-woven cotton belting to replace traditional plied cotton belting, i.e. one to six ply woven cotton belts. The non-woven cotton belt of the present invention has less stretch (higher modulus) than the traditional woven design.

The non-woven cotton belting of the present invention may be produced in wide rolls and then slit to order based on the requirements of the end user. In contrast, traditional woven cotton belting is woven to width and cannot be slit into smaller widths because it will unravel.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A conveyor belting for conveying bakery products, the conveyor belting comprising:
a scrim;
a batt of non-woven cotton fibers secured to a first side of the scrim by engagement of the fibers in the batt with the scrim, the engagement being of the character associated with needling and producing a needled scrim;
a polymeric material impregnated into the needled scrim; and,
an effective amount of antimicrobial compound to inhibit bacterial growth on the belting being operatively associated with the belting.

2. The conveyor belting of claim 1, wherein the scrim is woven.

3. The conveyor belting of claim 1, wherein the scrim is knitted.

4. The conveyor belting of claim 1, wherein the scrim is formed from substantially parallel yarns disposed in the machine direction.

5. The conveyor belting of claim 4, wherein the yarns are constructed of polyester.

6. The conveyor belting of claim 1, wherein the cotton fibers in the batt are randomly oriented.

7. The conveyor belting of claim 1, wherein the cotton fibers in the batt are directionally oriented.

8. The conveyor belting of claim 1, wherein the needled scrim is calendared.

9. The conveyor belting of claim 1, wherein the belting is embossed with a surface impression that simulates woven cotton belting.

10. The conveyor belting of claim 1, wherein a second batt of cotton fibers is needled to a second side of the scrim.

11. The conveyor belting of claim 1, wherein the antimicrobial compound is incorporated into the polymeric material.

12. The conveyor belting of claim 1, wherein the antimicrobial compound is incorporated in the batt.

13. The conveyor belting of claim 1, wherein the antimicrobial compound is applied to the surface of the belting.

14. The conveyor belting of claim 1, wherein the antimicrobial compound is selected from the group consisting of Ca(OH)₂, MgO, ZnO, Al₂O₃, CuO, Silver, Zinc Pyrithione, Methyl-N-(2-benzimidazoloyl)-carbamat, N-buthylbenso-thiazolinone, 10¹10-oxybisphenoxyarsin, Tebuconazole, Imidazole, and Silver-Sodium Hydrogen Zirconium Phosphate.

15. The conveyor belting of claim 4, wherein the antimicrobial compound is incorporated into the yarn.

16. A conveyor belting for conveying bakery products, the conveyor belting comprising:
a woven scrim having a plurality of substantially parallel textile yarns;
a batt of non-woven cotton fibers secured to the scrim by needling engagement to produce a needled scrim;
a polymeric material impregnated into the needled scrim and forming an impregnated, needled scrim;
an effective amount of antimicrobial compound to inhibit bacterial growth on the belting being operatively associated with the belting; and,
wherein the impregnated, needled scrim has a conveying surface with a pattern disposed thereon.

17. The conveyor belting of claim 16, wherein the cotton fibers are randomly oriented.

18. The conveyor belting of claim 16, wherein the cotton fibers are directionally oriented.

19. The conveyor belting of claim 16, wherein the pattern on the outer surface of the belting simulates a woven cotton belting surface.

20. The conveyor belting of claim 16, wherein antimicrobial compound is incorporated into the polymeric material.

21. The conveyor belting of claim 16, wherein the antimicrobial compound is incorporated in the batt.

22. The conveyor belting of claim 16, wherein the antimicrobial compound is applied to the surface of the belting.

23. The conveyor belting of claim 16, wherein the antimicrobial compound is selected from the group consisting of Ca(OH)₂, MgO, ZnO, Al₂O₃, CuO, Silver, Zinc Pyrithione, Methyl-N-(2-benzimidazoloyl)-carbamat, N-buthylbenso-thiazolinone, 10¹10-oxybisphenoxyarsin, Tebuconazole, Imidazole, and Silver-Sodium Hydrogen Zirconium Phosphate.

24. The conveyor belting of claim 16, wherein the antimicrobial compound is incorporated into the yarn.

25. A method of forming a conveyor belt, comprising:
providing a scrim;
needling a batt of cotton fibers to a first side of the scrim to produce a needled scrim;
impregnating the needled scrim with a polymeric material; and,
operatively associating an effective amount of an antimicrobial compound to inhibit bacterial growth on the belting.

26. The method of claim 25, wherein the scrim is woven.

27. The method of claim 25, wherein the scrim is knitted.

28. The method of claim 25, wherein the scrim comprises a plurality of substantially parallel textile yarns.

29. The method of claim 25, wherein the cotton fibers are randomly oriented.

30. The method of claim 25, wherein the cotton fibers are directionally oriented.

31. The method of claim 25, wherein the antimicrobial compound is incorporated into the polymeric material.

32. The conveyor belting of claim 25, wherein the antimicrobial compound is incorporated in the batt.

33. The conveyor belting of claim 25, wherein the antimicrobial compound is applied to the surface of the belting.

34. The conveyor belting of claim 25, wherein the antimicrobial compound is selected from the group consisting of Ca(OH)₂, MgO, ZnO, Al₂O₃, CuO, Silver, Zinc Pyrithione, Methyl-N-(2-benzimidazoloyl)-carbamat, N-buthylbenso-thiazolinone, 10¹10-oxybisphenoxyarsin, Tebuconazole, Imidazole, and Silver-Sodium Hydrogen Zirconium Phosphate.

35. The conveyor belting of claim 28, wherein the antimicrobial compound is incorporated into the yarn.

36. The method of claim 25, wherein a conveying surface of the belting is provided with a surface impression.

37. The method of claim 36, wherein the surface impression simulates the surface of a woven cotton belting.
